(19) United States
(12) Patent Application Publication
(10) Pub. No.: US 2016/0211048 A1
(43) Pub. Date: Jul. 21, 2016

(54) A Process For The Preparation Of A Conductive Polymer Composite

(71) Applicant: UNIVERSITE CATHOLIQUE DE LOUVAIN, Louvain-la-Neuve (BE)

(72) Inventors: Alexandru Vlad, Court-Saint-Etienne (BE); Jean-Francois Gohy, Neuville-en-Condroz (BE)

(21) Appl. No.: 14/917,249

(22) PCT Filed: Sep. 8, 2014
(86) PCT No.: PCT/EP2014/069106

§ 371 Date: Mar. 7, 2016

(30) Foreign Application Priority Data
Sep. 9, 2013 (EP) 13183549.8

(51) Int. Cl. H01B 1/20; H01M 4/62; H01B 1/24; H01B 1/22; C08K 3/04; C08F 220/34

(52) U.S. Cl. CPC H01B 1/20; C08K 3/04; C08F 220/34; H01B 1/24; H01B 1/22; H01M 4/622; H01M 2004/028

(57) ABSTRACT

The present invention relates to a process for the preparation of an electrically conductive polymer composite comprising the steps of (a) providing electrically conductive particles, a monomer, and a cross-linking agent to form a reaction mixture, (b) bringing said reaction mixture to a process temperature which is greater than the melting temperature of the monomer and than the temperature at which the polymerization is activated, said polymerization is considered to be activated when at least 5% of the monomer was converted, (c) retrieving a cross-linked electrically conductive polymer composite comprising said electrically conductive particles, characterized in that said monomer is of formula (I) R^{a}R^{b}C=CR^{c}((X)ₙ-R) and in that step (b) of the process is carried out in a reaction mixture comprising not more than 100 wt % of an organic solvent with respect to the total weight of the monomer. The present invention also relates to an electrically conductive polymer composite obtained by the present process.

### TECHNICAL FIELD

The present invention relates generally to polymerization carried out in a reaction mixture free or almost free of solvent for the preparation of an electrically conductive polymer composite. The present invention also relates to the electrically conductive polymer composite obtained therefrom.

### DESCRIPTION OF RELATED ART

As global warming and environmental problems become serious, electric cars or hybrid electric cars are actively developed as clean automobiles replacing gasoline cars. Energy storage devices used for such applications are required to achieve both high energy density and high output characteristics, and at the same time, a high durability and safety.

Electrodes used in battery usually comprise metal oxides that are known to be difficult to recycle, toxic and resource limited. Moreover, these oxides are known to be unstable when overcharged and responsible for safety issue like fire and explosion of the battery. Alternatively, redox polymers have been explored as a replacement for metal oxides. The main issue is that typically these polymers are soluble in typical battery electrolytes and they are poor electric conductors. Having a soluble or a partially soluble polymer implies limited cycle life time as the polymer is being slowly dissolved and migrates into the electrolyte. Poor electrical conductivity in turns results in low power performance, ie. slow charge and slow discharge when needed. Realizing composite with conductive additives has been found to solve the later. Realizing both, insoluble composites have been hindered by intrinsic material and technical limitations related to limited processability of an insoluble polymer. Such polymers are prepared in solution which requires high amount of solvent either for the polymerization or to precipitate the polymer formed in the solution. Further composite formation is difficult and shows low battery performance.

US2012/0100437 discloses electricity storage battery wherein the positive electrode comprises a conductive polymer composite comprising a polymer matrix made of poly(2,2,6,6-tetramethylpiperidinyl-oxy-4-yl-methacrylate), also named PTMA, and conductive particles, e.g. carbon fibers. The PTMA is prepared by polymerizing 2,2,6,6-tetramethylpiperidine methacrylate (TMPM) monomer in a tetrahydrofuran solution in presence of AIBN. The weight ratio between the solvent and the monomer is of 3.5. The polymer is further precipitated with hexane and oxidation is carried out in presence of m-chloroperoxybenzoic acid to form PTMA. The yield of the overall process for preparation of PTMA is only 80%. A positive electrode is prepared by dispersing the so-produced PTMA with carbon fibers and other additives in water. When the produced PTMA has low solubility in organic solvent, the electrical and capacity properties of the electrode required for battery applications are not achieved. Alternatively when the produced PTMA is soluble or partly soluble in organic solvent, the carbon fibers are homogeneously dispersed therein. The resulting electrode has, however, a limited life-cycle due to the dissolution of the PTMA during the discharge cycle. Hence, in both cases, electrodes produced with such PTMA lack efficacy for battery applications.

The present invention aims at providing a process that addresses the above-discussed drawbacks of the prior art.

In particular, it is an object of the present invention to provide an enhanced process for the preparation of conductive polymer composite. Another object of the present invention is to provide a conductive polymer composite suitable for battery applications.

### SUMMARY OF THE INVENTION

In a first aspect, the present invention provides a process for the preparation of an electrically conductive polymer composite comprising the steps of:

(a) providing electrically conductive particles, a monomer, and a cross-linking agent to form a reaction mixture,

(b) bringing said reaction mixture to a process temperature which is greater than the melting temperature of the monomer and than the temperature at which the polymerization is activated, said polymerization is considered to be activated when at least 5% of the monomer was converted,

(c) retrieving a cross-linked electrically conductive polymer composite comprising said electrically conductive particles,

characterized in that said monomer is of formula (I)

R^{a}R^{b}C=CR^{c}((X)ₙ-R) (I)

wherein

R^{a}, R^{b}, and R^{c} each are, independently from the other, hydrogen or an hydrocarbyl group having from 1 to 20 carbon atoms,

X is a spacer, n is an integer from 0 to 5,

R is a substituent able to form a radical under oxidative conditions or having a radical as functional group, and

in that step (b) of the process is carried out in a reaction mixture comprising not more than 100 wt %, preferably not more than 30 wt %, of a solvent with respect to the total weight of the monomer.

Preferably, the present process comprises the steps of:

(a) providing electrically conductive particles, a monomer, and a cross-linking agent to form a reaction mixture,

(b′) bringing said reaction mixture to a first process temperature to form a slurry where the polymerization reaction has not been initiated, said polymerization is considered to be not initiated when less than 5% of the monomer was converted,

(b″) heating said slurry to a second process temperature higher than the first process temperature to initiate the polymerization and thus to polymerize the monomer,

(c) retrieving a cross-linked electrically conductive polymer composite comprising said electrically conductive particles,

characterized in that said monomer is of formula (I)

R^{a}R^{b}C=CR^{c}((X)ₙ-R) (I)

wherein

R^{a}, R^{b}, and R^{c} each are, independently from the other, hydrogen or an hydrocarbyl group having from 1 to 20 carbon atoms,

X is a spacer, n is an integer from 0 to 5,

R is a substituent able to form a radical under oxidative conditions or having a radical as functional group, and

in that steps (b′) and (b″) of the process are carried out in a reaction mixture, preferably comprising not more than 100 wt %, more preferably not more than 30 wt %, of a solvent with respect to the total weight of the monomer.

In a preferred embodiment, R is a substituent having a nitroxide radical or a radical localized on a quinone or hydroquinone functional group; or R is a substituent having a nitrogen atom able to form nitroxide radicals under oxidative conditions or having quinone or hydroquinone functional groups.

The process according to the present invention is environmentally friendly due to the use of limited amount of solvent during the polymerization of the monomer. The present process allows the incorporation of the electrically conductive particles before carrying out the polymerisation step. The electrically conductive particles are therefore well-dispersed or homogeneously dispersed within the polymer matrix formed during the polymerization process (steps (b) or (b′) and (b″)). Furthermore, the overall yield for the preparation of the polymer composite is higher than 90%. The present process is a powerful alternative method to known polymerization in solution whereby the electrically conductive particles tend to agglomerate outside the polymer being formed. The conductive polymer composite prepared according to the present process is further insoluble and therefore suitable for the preparation of one of the components of battery.

In a preferred embodiment, the steps (b) or (b′) and (b″) of the present process are carried out in a reaction mixture free of any solvent, preferably free of any organic or aqueous solvent. When the monomer is solid at room temperature (25° C.), the reaction mixture may be heated at a process temperature equal to or greater than the melting temperature of the monomer. The melt monomer forms a slurry which allows the homogeneous dispersion of the electrically conductive particles before the polymerization of the monomer. When the monomer is liquid at room temperature (25° C.), the reaction mixture may be either maintain at room temperature and stir to form the slurry or heated to lower the viscosity of the monomer and to form the slurry, thus favouring the dispersion of the conductive particles.

In another aspect of the present invention, an electrically conductive polymer composite is provided. Said electrically conductive polymer composite is a cross-linked poly(2,2,6,6-tetramethyl-4-piperidinyl methacrylate) comprising from 0.01 to 50 wt % of electrically conductive particles, preferably from 0.1 to 30 wt %, more preferably from 0.5 to 20 wt %, most preferably from 1 to 20 wt % of electrically conductive particles based on the total amount of the polymer composite. According to the present process, the resulting polymer composite has excellent electrically conductive properties with respect to the low amount of conductive particles contained therein.

### BRIEF DESCRIPTION OF THE DRAWING

FIG. 1 illustrates schematically the dispersion of the electrically conductive particles within a polymer composite according to a preferred embodiment of the present invention and prepared according comparative processes.

FIG. 2 represents the scanning transmission electron micrographs of an oxidized conductive polymer composite according to a preferred embodiment of the present invention.

FIG. 3 represents a graph of the normalized capacity versus the cycle index of electrodes made of an electrically conductive polymer composite according to the present invention and of various polymer composite known in the art.

### DETAILED DESCRIPTION OF THE INVENTION

In a first aspect, the present invention provides a process for the preparation of an electrically conductive polymer composite comprising the steps of:

(a) providing electrically conductive particles, a monomer, and a cross-linking agent to form a reaction mixture,

(b) bringing said reaction mixture to a process temperature which is greater than the melting temperature of the monomer and than the temperature at which the polymerization is activated, said polymerization is considered to be activated when at least 5% of the monomer was converted,

(c) retrieving a cross-linked electrically conductive polymer composite comprising said electrically conductive particles, characterized in that said monomer is of formula (I)

R^{a}R^{b}C=CR^{c}((X)ₙ-R) (I)

wherein

R^{a}, R^{b}, and R^{c} each are, independently from the other, hydrogen or an hydrocarbyl group having from 1 to 20 carbon atoms,

X is a spacer, n is an integer from 0 to 5,

R is a substituent having a nitroxide radical or a radical localized on a quinone or hydroquinone functional group; or R is a substituent having a nitrogen atom able to form nitroxide radicals under oxidative conditions or having quinone or hydroquinone functional groups, and in that step (b) of the process is carried out in a reaction mixture comprising not more than 300 wt %, preferably not more than 250 wt %, more preferably not more than 100 wt %, most preferably not more than 30 wt %, of a solvent with respect to the total weight of the monomer. Hence, the amount of solvent to carry out step (b) of the process may be not more than 30 wt % with respect to the total weight of the monomer or ranging from more than 30 wt % to 100 wt % with respect to the total weight of the monomer. The components provided in step (a) may be mixed together before carrying out the step (b). Alternatively, step (b) of the process is carried out in a reaction mixture comprising from more than 30 wt % to 300 wt % of a solvent with respect to the total weight of the monomer, preferably from more than 30 wt % to 250 wt %, more preferably from more than 30 wt % to 200 wt %, most preferably from more than 100 wt % to 200 wt % of a solvent with respect to the total weight of the monomer. Said solvent may be an organic solvent.

Preferably, step (b) is carried out sequentially by: (b′) bringing said reaction mixture to a first process temperature to form a slurry where the polymerization reaction has not been initiated, said polymerization is considered to be not initiated when less than 5% of the monomer was converted, (b″) heating said slurry to a second process temperature higher than the first process temperature to initiate or propagate the polymerization and thus to polymerize the monomer.

Preferably, steps (b) or (b′) and (b″) of the process are carried out in a reaction mixture comprising not more than 300 wt %, preferably not more than 250 wt %, more preferably not more than 200 wt %, even more preferably not more than 100 wt %, most preferably not more than 30 wt % of an aqueous or organic solvent, even most preferably not more than 15 wt % of an aqueous or an organic solvent, in particular not more than 7 wt % of an aqueous or an organic solvent, more in particular not more than 3 wt % of an aqueous or an organic solvent with respect to the total weight of the monomer. The amount of solvent to carry out steps (b′) and (b″) of the process may be not more than 30 wt % with respect to the total weight of the monomer or ranging from more than 30 wt % to 100 wt % with respect to the total weight of the monomer. Alternatively, steps (b′) and (b″) of the process may be carried out in a reaction mixture comprising from more than 30 wt % to 300 wt % of a solvent with respect to the total weight of the monomer, preferably from more than 30 wt % to 250 wt %, more preferably from more than 30 wt % to 200 wt %, most preferably from more than 100 wt % to 200 wt % of a solvent with respect to the total weight of the monomer. The solvent used in steps (b) or (b′) and (b″) of the process may dissolve the monomer and preferably the cross-linking agent. For example, the solvent may be dichloromethane, chloroform, toluene, benzene, acetone, ethanol, methanol, hexane, N-methyl pyrrolidone, dimethylsulfoxide, acetonitrile, tetrahydrofuran or dioxane.

In particular, the steps (b) or (b′) and (b″) of the process are carried out in a reaction mixture free of any aqueous or organic solvent. The process is therefore advantageously environmental friendly and the manufacturing costs are also reduced.

Step (a) of the present process may further comprise the addition of solvent to disperse the electrically conductive particles, the monomer, and the cross-linking agent. Said solvent is preferably removed before carrying out the subsequent steps of the process. Instead of adding a solvent, the electrically conductive particles, the monomer, and the cross-linking agent provided in step (a) may be mixed with a ball milling system before carrying out the subsequent steps of the process. Alternatively, a dispersion media may be provided in step (a) of the present process. The dispersion media may be insoluble or immiscible with respect to said solvent and/or said monomer used in steps (b) or (b′) and (b″). Preferably, the dispersion media may be water. The dispersion media may be added to form in step (a) an emulsion or a suspension.

In a preferred embodiment, the cross-linked electrically conductive polymer composite obtained in step (c) has solubility lower than 10 wt % in any solvent at room temperature, preferably lower than 5 wt %, more preferably lower than 1 wt %, most preferably lower than 0.1 wt %. The electrically conductive polymer composite obtained in step (c) may have solubility lower than 10 wt % in organic solvent or water at room temperature, preferably lower than 5 wt %, more preferably lower than 1 wt %, most preferably lower than 0.1 wt %. In particular, said electrically conductive polymer composite may be insoluble in any solvent, preferably in any organic or aqueous solvent. For example, the electrically conductive polymer composite may be insoluble in dichloromethane, chloroform, toluene, benzene, acetone, ethanol, methanol, hexane, N-methyl pyrrolidone, dimethylsulfoxide, acetonitrile, tetrahydrofuran and/or dioxane. An insoluble electrically conductive polymer composite is of great interest in energy storage applications or battery applications, in particular when said electrically conductive polymer composite has a radical as functional group. If the electrically conductive polymer composite does not bear a radical, it may be used for the preparation of an oxidized electrically conductive polymer composite having the same physical (insolubility in organic solvent) and electrical properties (due to homogeneous dispersion of the conductive particles therein). The oxidation of said electrically conductive polymer composite may form radical along the polymer chain. The electrically conductive polymer composite, oxidized or not but having radical, incorporated in a battery, for example as one of the constituent of a positive electrode, will therefore not be solubilized in the electrolyte when the battery will be charged/discharged or stored. The resulting electrode prepared according to the present invention will therefore have higher capacity retention rate over time. The degradation of the electrode is strongly limited and the life-cycle of the electrode is increased.

In a preferred embodiment, the process further provides in step (a), a polymerization initiator, preferably a radical polymerization initiator. Hence, step (b) of the process may be bringing or heating said reaction mixture to a process temperature which is greater than the melting temperature of the monomer and greater than the temperature at which the polymerization initiator was decomposed, i.e. the temperature at which the polymerization is initiated by the polymerization initiator.

In a preferred embodiment, when step (b) is carried out sequentially, step (b′) of the present process may be bringing said reaction mixture to a first process temperature to form a slurry where the polymerization reaction was not initiated, said polymerization is considered to be not initiated when less than 5 wt % of the monomer was converted; and step (b″) heating said slurry to a second process temperature higher than the first process temperature such that the polymerization initiator initiates or propagates the polymerization of the monomer.

In the present process, the first process temperature may be higher or equal to the melting temperature of the monomer.

In a preferred embodiment, the melting temperature of the monomer is lower than the temperature at which the polymerization of the monomer is initiated. The melting temperature of the monomer may be lower than the temperature at which the polymerization initiator, preferably the radical polymerization initiator, is decomposed. Generally, the decomposition of the polymerization initiator will activate or propagate the polymerization of the monomer. The polymerization initiator may decompose slowly or gradually when increasing the temperature. The conversion of the monomer to polymer may be lower than 5 wt % when at most 7 wt % of the polymerization initiator was decomposed, preferably at most 4 wt %, more preferably at most 1 wt %. When the reaction mixture is heated during step (b′) of the present process to the melting temperature of the monomer, said monomer melts before the polymerization thereof is initiated. The dispersion of the conductive particles is therefore more homogeneous within the reaction mixture, i.e. the slurry. The polymer so-formed will have better electrical conductivity due to the controlled dispersion of the conductive particles.

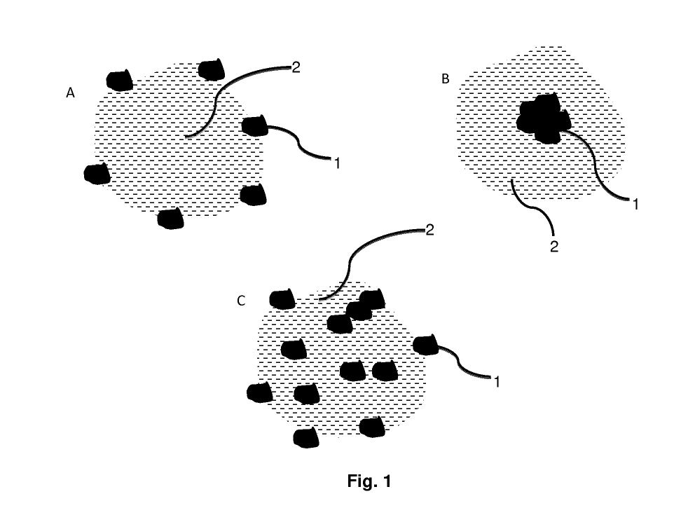

FIG. 1 illustrates schematically the dispersion of the electrically conductive particles within a polymer composite according to a preferred embodiment of the present invention and prepared according comparative processes. FIG. 1 A represents a comparative polymer composite wherein the conductive particles 1 are dispersed at the surface of the polymer particle 2. This configuration is obtained when an insoluble polymer composite 2 is blended with conductive particles 1. The inner surface of the polymer particle 2 cannot be electrically accessed. FIG. 1 B represents a comparative polymer composite wherein the conductive particles 1 are agglomerated in the polymer particles 2. This configuration is obtained if a soluble polymer composite 2 is processed and coated on electrically conductive fibers/particles 1. The electrical contact between the carbon particles/fibers is lost because of the insulating nature of polymer composite. Furthermore, a soluble polymer composite will be degraded easily over time. FIG. 1 C represents an electrically conductive polymer composite or an oxidized electrically conductive polymer composite according to the present invention. The conductive particles 1 are uniformly dispersed within and around the polymer particle 2. This configuration allows said polymer composite of the present invention to have the properties detailed herein.

The slurry formed in step (b′) may be maintained at the first process temperature preferably under stirring conditions to homogeneously disperse the conductive particles while maintaining the slurry at a low and substantially constant viscosity prior to step (b″). The term “low viscosity” refers to a viscosity lower than 5.10³ Pa·s, preferably lower than 3.10³ Pa·s, more preferably lower than 10³ Pa·s. Said slurry can be easily stirred to allow the dispersion of the conductive particles therein before the viscosity thereof raises a higher viscosity (due to the polymerization) at which the homogenization of the slurry is not more possible.

In particular, the slurry is maintained at the first process temperature for a time of at least 20 seconds, preferably of at least 30 seconds, more preferably for at least 60 seconds. The dispersion of the conductive particles in the slurry is therefore controlled before the polymerization of the monomer is initiated. Said slurry may be maintained at the first process temperature less than 5minutes, preferably less than two minutes, preferably less than one minute.

As mentioned above, the monomer used in the present process is of formula (I) R^{a}R^{b}C=CR^{c}((X)ₙ-R) (I) wherein R^{a}, R^{b}, and R^{c} each are, independently from the other, hydrogen or an hydrocarbyl group having from 1 to 20 carbon atoms, X is a spacer, n is an integer from 0 to 5, R is a substituent having a radical, or a substituent able to form a radical under oxidative conditions. In a preferred embodiment, the monomer is of formula (I) wherein R is a substituent having a nitrogen atom able to form nitroxide radicals under oxidative conditions, R is a substituent having quinone or hydroquinone functional groups or R is a substituent having a nitroxide radical or a radical localized on a quinone or hydroquinone functional group. A radical refers herein as an atom or molecule having unpaired valence electrons. The term “nitroxide radical” refers to “N—O—” functional group.

Preferably, the monomer is of formula (I) R^{a}R^{b}C=CR^{c}((X)ₙ-R) (I) wherein R^{a}, R^{b}, and R^{c} each are, independently from the other, hydrogen or C₁C₆ alkyl or C₆-C₁₈ aryl;

X is a spacer, n is an integer from 0 to 5, preferably from 0 to 2, more preferably n is 0,

R is a substituent having a radical or able to form a radical under oxidative conditions; preferably R is a substituent having a nitroxide radical or a nitrogen atom able to form nitroxide radical under oxidative conditions;

in particular, R^{a}, R^{b}, R^{c} may be hydrogen or methyl and n is 0.

In a preferred embodiment, the monomer is of formula (I) wherein X is selected from the group consisting of C₁-C₂₀ alkyl, C₆-C₂₀ aryl, C₂-C₂₀ alkenyl, C₃-C₂₀ cycloalkyl, C₁-C₂₀ alkoxyl, —C(O)—, O—C(O)—, —CO₂—, C₁C₂₀ ether, C₁C₂₀ ester. Preferably, X may be selected from the group consisting of C₁-C₆ alkyl, C₆-C₁₂ aryl, C₂-C₆ alkenyl, C₃-C₁₀ cycloalkyl, C₁-C₆ alkoxyl, —C(O)—, O—C(O)—, —CO₂—, C₁-C₆ ether, C₁-C₆ ester. More preferably, X may be selected from the group consisting of C₁-C₆ alkyl, C₆-C₁₂ aryl, C₂-C₆ alkenyl, C₁-C₆ alkoxyl, —C(O)—, O—C(O)—, —CO₂—.

The monomer may have a radical as functional group. The monomer may be of formula (I) wherein R is a substituent having a nitroxide radical. The monomer may be of formula (I) as defined above wherein R is selected from the group consisting of:

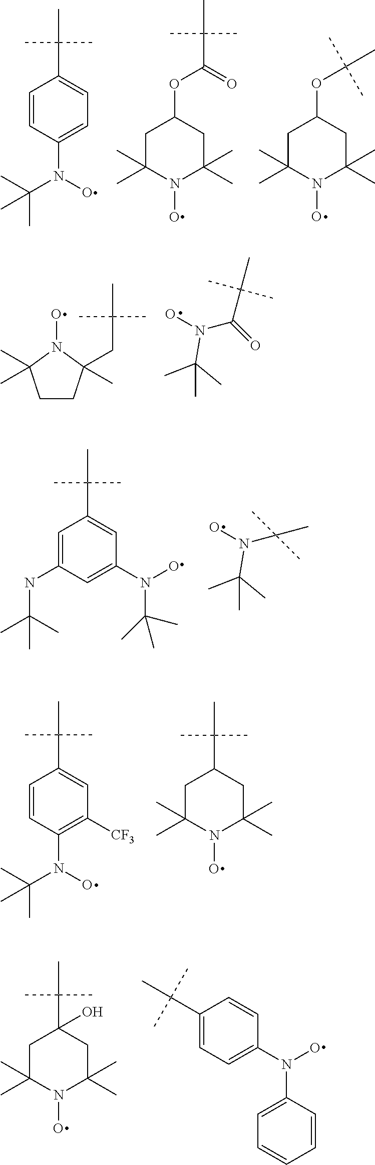

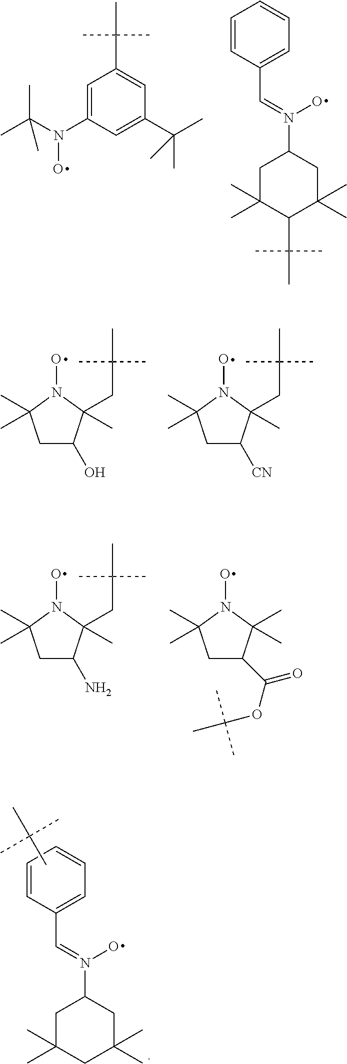

For sake of clarity, hydrogen atoms are not represented on the above substituents. The dotted lines cross the chemical bond by which the substituent is linked to the spacer X or to the carbon atom of the vinyl group of the formula (I). Preferably, the monomer may be of formula (I) as detailed above wherein R is selected from the group consisting of:

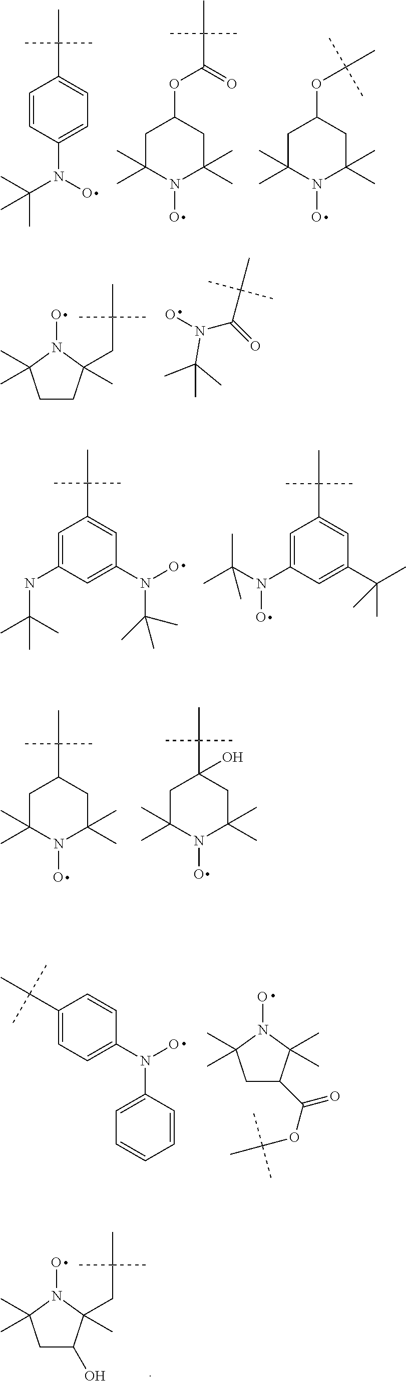

More preferably the monomer may be 2,2,6,6-tetramethylpiperidinyl-oxy-4-yl methacrylate.

The monomer may be of formula (I) wherein R is a substituent having a nitrogen atom able to form nitroxide radicals under oxidative conditions. Preferably, R is a substituent selected from the group consisting of the following substituents:

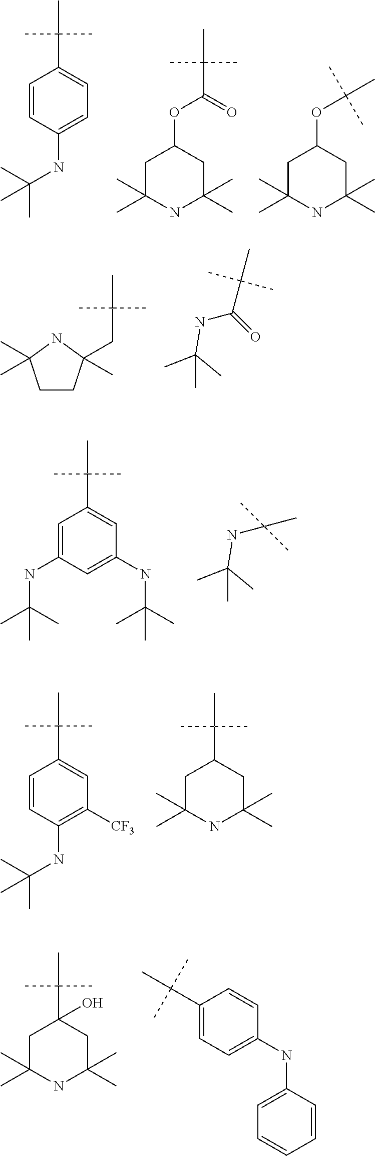

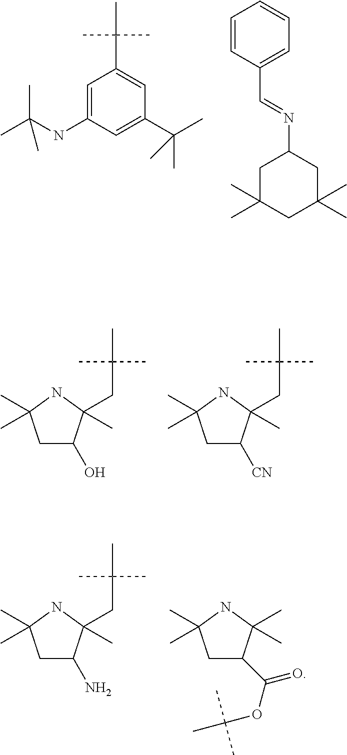

For sake of clarity, hydrogen atoms are not represented on the above substituents. The dashed lines cross the chemical bond by which the substituent R is linked to the spacer X or to the carbon atom of the vinyl group of the formula (I).

In particular, R is a substituent selected from the group consisting of:

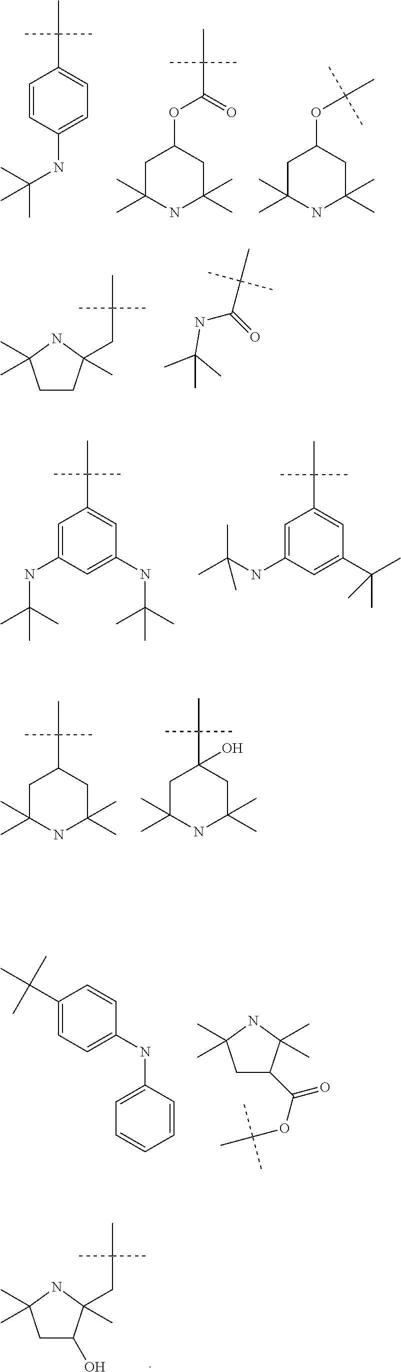

Preferably, the monomer is 2,2,6,6-tetramethyl-4-piperidinyl methacrylate.

The amount of electrically conductive particles may range from 0.01 to 50 wt %, preferably from 0.1 to 30 wt %, more preferably from 0.5 to 20 wt %, most preferably from 1 to 20 wt %, even most preferably from 5 to 20 wt %, in particular from 5 to 15 wt % based on the total amount of the conductive polymer composite.

The electrically conductive particles may be carbon conductive particles or, metallic nanowires or particles selected from the group consisting of silver, nickel, iron, copper, zinc, gold, tin, indium and oxides thereof. Preferably, the carbon conductive particles may be carbon nanotubes, carbon fibers, amorphous carbon, mesoporous carbon, carbon black, exfoliated graphitic carbon, activated carbon or surface enhanced carbon.

Nanotubes can exist as single-walled nanotubes (SWNT) and multi-walled nanotubes (MWNT), i.e. nanotubes having one single wall and nanotubes having more than one wall, respectively. In single-walled nanotubes a one atom thick sheet of atoms, for example a one atom thick sheet of graphite (also called graphene), is rolled seamlessly to form a cylinder. Multi-walled nanotubes consist of a number of such cylinders arranged concentrically. The arrangement in a multi-walled nanotube can be described by the so-called Russian doll model, wherein a larger doll opens to reveal a smaller doll.

In an embodiment, the nanotubes are multi-walled carbon nanotubes, more preferably multi-walled carbon nanotubes having on average from 5 to 15 walls.

Nanotubes, irrespectively of whether they are single-walled or multi-walled, may be characterized by their outer diameter or by their length or by both.

Single-walled nanotubes are preferably characterized by an outer diameter of at least 0.5 nm, more preferably of at least 1 nm, and most preferably of at least 2 nm. Preferably their outer diameter is at most 50 nm, more preferably at most 30 nm and most preferably at most 10 nm. Preferably, the length of single-walled nanotubes is at least 0.1 μm, more preferably at least 1 μm, even more preferably at least 10 μm. Preferably their length is at most 50 μm, more preferably at most 25 μm.

Multi-walled nanotubes are preferably characterized by an outer diameter of at least 1 nm, more preferably of at least 2 nm, 4 nm, 6 nm or 8 nm, and most preferably of at least 10 nm. The preferred outer diameter is at most 100 nm, more preferably at most 80 nm, 60 nm or 40 nm, and most preferably at most 20 nm. Most preferably, the outer diameter is in the range from 10 nm to 20 nm. The preferred length of the multi-walled nanotubes is at least 50 nm, more preferably at least 75 nm, and most preferably at least 100 nm. Their preferred length is at most 20 mm, more preferably at most 10 mm, 500 μm, 250 μm, 100 μm, 75 μm, 50 μm, 40 μm, 30 μm or 20 μm, and most preferably at most 10 μm. The most preferred length is in the range from 100 nm to 10 μm. In an embodiment, the multi-walled carbon nanotubes have an average outer diameter in the range from 10 nm to 20 nm or an average length in the range from 100 nm to 10 μm or both.

Preferred carbon nanotubes are carbon nanotubes having a surface area of 200-400 m²/g (measured by BET method). Preferred carbon nanotubes are carbon nanotubes having a mean number of 5-15 walls.

The carbon conductive particles may be almost spherical. The mean diameter of said carbon conductive particles may range from 0.1 to 500 nm, preferably from 0.5 to 250 nm, more preferably from 1 to 100 nm, most preferably from 1 to 50 nm, and in particular from 5 to 20 nm. The term “mean diameter” refers to longest linear distance between two points inside the particle.

The cross-linking agent used in the present process may be one commonly used by the skilled person. In particular, the cross-linking agent may be ethylene glycol dimethacrylate, butanediol dimethylacrylate, hexanediol dimethylacrylate, nonanediol dimethylacrylate, decanediol dimethylacrylate, dodecanediol dimethylacrylate, diethylene glycol methacrylate, triethylene glycol dimethylacrylate, ethylene glycol divinyl ether, butanediol divinyl ether, hexanediol divinyl ether, nonanediol divinyl ether, decanediol divinyl ether, dodecanediol divinyl ether, diethylene glycol divinyl ether, triethylene glycol divinyl ether, N-(1-hydroxy-2,2-dimethoxyethyl)acrylamide, divinylbenzene, tri-allyl cyanurate, dioctyl maleate, 1-(acryloyloxy)-3-(methacryloyloxy)-2-propanol, 1,3-glyceryl dimethylacrylate, 1,4-diacryloylpiperazine, 1,4-phenylene diacrylate, pentanediol dimethylacrylate, hexanediol dimethylacrylate, nonanediol dimethylacrylate, 2,2-bis(4-methacryloxyphenyl)propane, 2,2-bis[4-(2-acryloxyethoxy)phenyl]propane, 2,2-bis[4-(2-hydroxy-3-methacryloxypropoxy)phenyl]propane, 2,2-dimethylpropanediol dimethacrylate, 2-hydroxypropyl acrylate, 4-hydroxybutyl acrylate, barium methacrylate, bis(2-methacryloxyethyl)-N,N′-1,9-nonylene biscarbamate, bis(2-methacryloxyethyl) phosphate, bisphenol A-bis(2-hydroxypropyl) acrylate, copper (II) methacrylate, fluorescein dimethylacrylate, lead acrylate, magnesium acrylate, N,N′-ethylene bisacrylamide, N,N′-hexamethylenebisacrylamide, N,N′-methylenebisacrylamide, N,N′-cystaminebisacrylamide, N,N′-diallylacrylamide, N-hydroxyethyl acrylamide, PEO(5800)-b-PPO(3000)-b-PEO(5800) dimethylacrylate, polyethyleneglycol(8000) dimethylacrylate, tetraethylene glycol dimethylacrylate, trans-1,4-cyclohexanediol dimethylacrylate, tricyclodecane dimethanol diacrylate, zinc dimethylacrylate. The cross-linking agent allows the increase of the degree of cross-linking in the polymer composite and then influences its insolubility in the organic solvent. In particular, the desired degree of cross-linking of the polymer composite is achieved with a cross-linking agent selected from the group consisting of ethylene glycol dimethacrylate, butanediol dimethylacrylate, hexanediol dimethylacrylate, Nonanediol dimethylacrylate, decanediol dimethylacrylate, dodecanediol dimethylacrylate, diethylene glycol methacrylate, triethylene glycol dimethylacrylate.

The cross-linking degree defined as the molar ratio between the monomer and the cross-linking agent, ranges from 1 to 1000, preferably from 5 to 100, more preferably from 10 to 50.

The cross-linking in the polymer can be expressed also as a percentage. The percentage of cross-linking is the molar ratio between the cross linking agent and monomer, multiplied by 100% The percentage of cross-linking in the conductive polymer composite ranges from 0.1 to 15%, preferably from 0.5 to 10%, more preferably from 1 to 8%, most preferably from 3 to 7%.

The polymerization initiator optionally used in the present process may be a radical or anionic polymerization initiator. The anionic polymerization initiator may be n-butyllithium, sec-butyllithium, KOH, NaOH, KNH₂, Na.

The radical polymerization initiator may be a peroxide or azo compound R¹-N═N-R². The azo compound encompasses aryl azo compound and alkyl azo compound. Hence, the azo compound may be of formula R¹-N═N-R² wherein R¹ and R² are each, independently from the other, hydrogen, C₁-C₂₀ alkyl optionally substituted by one or more functional groups selected from the group consisting of CN, OH, halogen, CO₂R⁵, C(0)R⁵, OC(O)R⁵ wherein R⁵ is C₁-C₆ alkyl, C₆-C₁₈ aryl, C₂-C₆ alkenyl, C₂-C₆ alkenyl; C₆-C₂₀ aryl optionally substituted by one or more functional groups selected from the group consisting of CN, OH, halogen, CO₂R⁵, C(O)R⁵, OC(O)R⁵ wherein R⁵ is C₁-C₆ alkyl, C₆-C₁₈ aryl, C₂-C₆ alkenyl, C₂-C₆ alkenyl; C₁-C₂₀ alkoxide, C₁-C₂₀ ether, C₂-C₂₀ alkenyl, C₂-C₂₀ alkenyl. The peroxide compound may be of formula R³-O—O—R⁴ wherein R³ and R⁴ are each, independently from the other, hydrogen C₁-C₂₀ alkyl optionally substituted by one or more functional groups selected from the group consisting of CN, OH, halogen, CO₂R⁵, C(O)R⁵, OC(O)R⁵ wherein R⁵ is C₁-C₆ alkyl, C₆-C₁₈ aryl, C₂-C₆ alkenyl, C₂-C₆ alkenyl; C₆-C₂₀ aryl optionally substituted by one or more functional groups selected from the group consisting of CN, OH, halogen, CO₂R⁵, C(O)R⁵, OC(O)R⁵ wherein R⁵ is C₁-C₆ alkyl, C₆-C₁₈ aryl, C₂-C₆ alkenyl, C₂-C₆ alkenyl; C₁-C₂₀ alkoxide, C₁-C₂₀ ether, C₂-C₂₀ alkenyl, C₂-C₂₀ alkenyl, —OC(O)R⁶, —C(O)—O(R⁶) wherein R⁶ is C₁-C₆ alkyl, C₆-C₁₈ aryl, C₂-C₆ alkenyl, C₂-C₆ alkenyl; C₁-C₂₀ alkoxide, C₁-C₂₀ ether, C₂-C₂₀ alkenyl, C₂-C₂₀ alkenyl.

When a polymerization initiator is used in the present process, it needs to be activated or decomposed at the second process temperature to initiate or propagate the polymerization. In a preferred embodiment, the polymerization initiator may have an activation or decomposition temperature higher than the melting temperature of the monomer used in the present process or higher than the first process temperature. In particular, the polymerization initiator may be a radical polymerization initiator, preferably AIBN.

In a more preferred embodiment, the monomer used in the present process is 2,2,6,6-tetramethyl-4-piperidinyl methacrylate which has a melting temperature of 61° C. The radical polymerization initiator may have decomposition or activation temperature higher than 61° C. AIBN which is preferably used in the present process as radical polymerization initiator carries out polymerization at a temperature greater than 70° C. Preferably, the step (b′) of the present process may be bringing the reaction mixture at a first process temperature ranging from the melting temperature of the monomer, for example the melting temperature of 2,2,6,6-tetramethyl-4-piperidinyl methacrylate, to the activation or decomposition temperature of the radical polymerization initiator, for example the decomposition temperature of AIBN, to melt the monomer and to form the slurry. Further, the slurry is heated at the second process temperature at which or above which the radical polymerization initiator decomposed and the polymerization is activated, in particular at a temperature of at least 70° C. when AIBN is used as the radical polymerization initiator. The polymerization thus provides an electrically conductive polymer composite which is preferably insoluble in organic solvent.

In particular, the present process provides a cross-linked poly(2,2,6,6-tetramethyl-4-piperidinyl methacrylate). Carbon particles are easily and well-dispersed within the cross-linked poly(2,2,6,6-tetramethyl-4-piperidinyl methacrylate) according to the present process. Alternatively, the present process provides a cross-linked poly(2,2,6,6-tetramethylpiperidinyl-oxy-4-yl methacrylate). Carbon particles are also easily and well-dispersed within the cross-linked poly(2,2,6,6-tetramethylpiperidinyl-oxy-4-yl methacrylate) according to the present process.

The present process may further comprise the step (d) of oxidizing the electrically conductive polymer composite retrieving in step (c) of the present process to form an oxidized electrically conductive polymer composite. Step (d) may be carried out in presence of an oxidant able to oxidize a nitrogen atom to form a nitroxide radical or to oxidize an oxygen atom from a quinone or a hydroquinone functional group to form an oxygen radical. Hence, said oxidized electrically conductive polymer composite has at least one nitroxide radical or oxygen radical. The oxidant may be, but is not limited to, oxygen, ozone, hydrogen peroxide, peroxide compound of formula R³-O—O—R⁴ as defined above, fluorine, chlorine, iodine, bromine, nitric acid, sulphuric acid, peroxydisulfuric acid, peroxymonosulfuric acid, compounds bearing chlorite, chlorate or perchlorate functional group, permanganate compounds such as potassium permanganate, hypochlorite compounds, hexavalent chromium compounds, sodium perborate, nitrous oxide, silver oxide, 2,2′-Dipyridyldisulfide. Peroxide compounds of formula R³-O—O—R⁴ as defined above are particularly preferred. In particular, metachloroperoxybenzoic acid is preferred. Step (d) of the present process may be carried out in presence of any organic solvent such as for example toluene, dichloromethane or tetrahydrofuran. Typically, step (d) of the present process is carried out when the electrically conductive polymer composite obtained in step (c) is free of any radical, preferably free of any nitroxide radical.

In a preferred embodiment, the electrically conductive polymer composite or the oxidized electrically conductive polymer composite has solubility lower than 10 wt % in organic solvent at room temperature, preferably lower than 5 wt %, more preferably lower than 1 wt %, most preferably lower than 0.1 wt %. In particular, it may be insoluble in any solvent, preferably in any organic or aqueous solvent. For example, it may be insoluble in dichloromethane, toluene, acetone, hexane, dichloromethane, chloroform, toluene, benzene, acetone, ethanol, methanol, hexane, N-methyl pyrolidone, dimethyl sulfoxyde, acetonitrile, tetrahydrofuran, dioxane. An insoluble oxidized electrically conductive polymer composite or an electrically conductive polymer composite bearing a radical, preferably a nitroxide radical, is of great interest in energy storage applications or battery applications. When these polymer composites are incorporated in a battery, for example as one of the constituent of the positive electrode, they will therefore not be solubilized in the electrolyte, for example when the battery will be a discharge phase. An electrode containing the electrically conductive polymer composite or the oxidized electrically conductive polymer composite according to the present invention will therefore have higher capacity retention rate over time and the battery will have longer life-time. The degradation of the electrode is strongly limited.

The oxidized electrically conductive polymer composite prepared according to the present process may have a percentage of cross-linking, as defined above, ranging from 0.1 to 15%, preferably from 0.5 to 10%, more preferably from 1 to 8%, most preferably from 3 to 7%.

The preparation of the electrically conductive polymer composite obtained at the end of step (c) of the present process is carried out with a yield higher than 95%. The preparation of the oxidized electrically conductive polymer composite obtained at the end of step (d) of the present process is carried out with an overall yield higher than 90%. The present process is therefore more efficient than the process known in the art whereby an overall yield for obtaining an oxidized electrically conductive polymer composite is around 80%.

In a preferred embodiment, the monomer used may be 2,2,6,6-tetramethyl-4-piperidinyl methacrylate and the present process provides in step (c) a cross-linked poly(2,2,6,6-tetramethyl-4-piperidinyl methacrylate). Step (d) of the present process may be carried out in presence of said cross-linked poly(2,2,6,6-tetramethyl-4-piperidinyl methacrylate) obtained at the end of step (c). In particular, said cross-linked poly(2,2,6,6-tetramethyl-4-piperidinyl methacrylate) may be oxidized with meta-chloroperoxybenzoic acid to provide poly(2,2,6,6-tetramethylpiperidinyl-oxy-4-yl methacrylate) also named PTMA. In another preferred embodiment, the monomer used may be 2,2,6,6-tetramethylpiperidinyl-oxy-4-yl methacrylate and the present process provides in step (c) a cross-linked poly2,2,6,6-tetramethylpiperidinyl-oxy-4-yl methacrylate) without carrying out step (d) detailed above due to the presence of a nitroxide radical.

The electrically conductive polymer, oxidized or not, according to the present invention may have output energy density greater than 240 Wh/kg, preferably greater than 250 Wh/kg, more preferably greater than 260 Wh/kg most preferably greater than 270 Wh/kg at a power density of 3.5 kW/kg (10C). The electrically conductive polymer according to the present invention may also have output energy density greater than 170 Wh/kg, preferably greater than 180 Wh/kg, more preferably greater than 185 Wh/kg most preferably greater than 195 Wh/kg at power density of 10.23 kW/kg (30C). The above-mentioned values of output energy density may be preferably observed when a cross-linked poly2,2,6,6-tetramethylpiperidinyl-oxy-4-yl methacrylate) is obtained at the end of the present process (steps (c) or (d)). Such high output energy density may be obtained due to the particular steps of the present process allowing the homogeneous dispersion of the electrically conductive particles within the polymer so-formed. In particular, such output energy density values may be obtained for electrically conductive polymer as defined above comprising from 5 to 20 wt % of electrically conductive particles, preferably electrically conductive carbon particles as defined herein, based on the total amount of the conductive polymer composite which is preferably a cross-linked poly2,2,6,6-tetramethylpiperidinyl-oxy-4-yl methacrylate). The output energy density is measured according to standard charge/discharge experiments. The battery was charged at slow rate and then discharged at higher rates. Discharge time (t), discharge current (I) and average discharge voltage are directly extracted from the experiment. The output energy density is calculated by (l*V*t)/m wherein m is the mass of the electrically conductive polymer. The power density is calculated by I*V/m.

The present process may further comprise the steps of grinding and/or milling the electrically conductive polymer composite or the oxidized electrically conductive polymer composite. The electrically conductive polymer composite or the oxidized electrically conductive polymer composite thus obtained may have a mean diameter of less than 10 μm, preferably less than 1 μm, more preferably less than 100 nm. The electrically conductive polymer composite or the oxidized electrically conductive polymer composite thus obtained may have a mean diameter of at least 1 nm, preferably of at least 10 nm.

An electrically conductive polymer composite is provided by the present invention. Said electrically conductive polymer composite comprises from 0.01 to 50 wt % of electrically conductive particles, preferably from 0.1 to 30 wt %, more preferably from 0.5 to 20 wt %, most preferably from 1 to 20 wt % of conductive particles based on the total amount of the conductive polymer composite.

The electrically conductive polymer composite may have solubility lower than 10 wt % in organic solvent at room temperature, preferably lower than 5 wt %, more preferably lower than 1 wt %, most preferably lower than 0.1 wt %. In particular, said electrically conductive polymer composite may be insoluble in any solvent, preferably in any organic solvent or water. The presence of cross-linking within the electrically conductive polymer composite favours the insolubility thereof in any organic or aqueous solvent. This is of particular interest when the electrically conductive polymer composite is used in the preparation of an oxidized electrically conductive polymer composite suitable for electrode and battery applications. The life cycle of the electrode and of the battery comprising the oxidized electrically conductive polymer composite is increased. The electrically conductive polymer composite according to the present invention may have a percentage of cross-linking ranging from 0.1 to 15%, preferably from 0.5 to 10%, more preferably from 1 to 8%, most preferably from 3 to 7%.

The electrical conductivity of said electrically conductive polymer composite may be higher than the one obtained for the same conductive polymer composite but prepared in solution polymerization, at same conductive particles content. The conductive polymer composite obtained by the present process, in absence of solvent or in low amount of solvent compared to the monomer, allows the homogeneous dispersion of the conductive particles within the polymer composite. The power performance, such as output energy density mentioned above, of the electrically conductive polymer composite may also be greater than the one obtained for the same conductive polymer composite but prepared in solution polymerization, at same conductive particles content.

An oxidized electrically conductive polymer composite is provided according to the present invention. The oxidized electrically conductive polymer composite may comprise from 0.01 to 50 wt % of electrically conductive particles based on the total amount of the oxidized electrically conductive polymer composite, preferably from 0.1 to 30 wt %, more preferably from 0.5 to 20 wt %, most preferably from 1 to 20 wt %. Preferably, the electrically conductive particles are carbon conductive particles as defined above.

The oxidized electrically conductive polymer composite may have solubility lower than 10 wt % in organic solvent at room temperature, preferably lower than 5 wt %, more preferably lower than 1 wt %, most preferably lower than 0.1 wt %. The presence of cross linking within the oxidized electrically conductive polymer composite allows it to be insoluble in any organic solvent. This is of particular interest when the oxidized conductive polymer composite is used in an electrode for battery. The polymer composite does not dissolve in the electrolyte which increases the life cycle of the electrode and of the battery comprising the same. The oxidized electrically conductive polymer composite according to the present invention may have a percentage of cross-linking ranging from 0.1 to 15%, preferably from 0.5 to 10%, more preferably from 1 to 8%, most preferably from 3 to 7%.

Electrical conductivity of the oxidized electrically conductive polymer composite is higher than the one obtained for the same conductive polymer composite but prepared in solution polymerization, at same conductive particles content. The oxidized electrically conductive polymer composite obtained by the present process allows the homogeneous dispersion of the conductive particles within the insoluble oxidized conductive polymer composite. With such a homogenous conductive network within an insoluble polymer composite, the latter can be suitable as one of the component of an electrode in battery. The performance profile of a battery wherein an electrode, for example the positive electrode, comprise the electrically conductive polymer composite of the present invention or an oxidized conductive polymer composite obtained by the present process is strongly enhanced.

The electrically conductive polymer composite or the oxidized electrically conductive polymer composite obtained therefrom are useful in energy storage devices, preferably in electrodes for battery. A positive electrode comprising an oxidized or not electrically conductive polymer composite according to the present invention is provided. Preferably, the positive electrode may comprise cross-linked poly2,2,6,6-tetramethylpiperidinyl-oxy-4-yl-methacrylate) according to the present invention and prepared according to the present process. As described above, a cross-linked poly2,2,6,6-tetramethylpiperidinyl-oxy-4-yl-methacrylate) may be obtained either at step (c) or step (d) of the present process depending on the monomer provided in step (a).

The present invention provides, as electrically conductive polymer composite, a cross-linked poly2,2,6,6-tetramethyl-4-piperidinyl methacrylate) comprising from 0.01 to 50 wt %, preferably from 0.1 to 30 wt %, more preferably from 0.5 to 20 wt %, most preferably from 1 to 20 wt % of electrically conductive particles based on the total amount of the electrically conductive polymer composite. The carbon conductive particles may be homogeneously dispersed within the cross-linked poly2,2,6,6-tetramethyl-4-piperidinyl methacrylate).

The present invention provides, as electrically conductive polymer composite or oxidized electrically conductive polymer composite, a cross-linked poly2,2,6,6-tetramethylpiperidinyl-oxy-4-yl-methacrylate) comprising from 0.01 to 50 wt % of electrically conductive particles, preferably from 0.1 to 30 wt %, more preferably from 0.5 to 20 wt %, most preferably from 1 to 20 wt % of conductive particles based on the total amount of, the oxidized or not, electrically conductive polymer composite. The carbon conductive particles may be homogeneously dispersed within the cross-linked poly2,2,6,6-tetramethylpiperidinyl-oxy-4-yl-methacrylate). Preferably, the mean carbon-to-carbon particle distance ranges from 1 to 100 nm, preferably from 5 to 50 nm, more preferably from 10 to 30 nm in said cross-linked poly2,2,6,6-tetramethylpiperidinyl-oxy-4-yl-methacrylate). Preferably, the particle-to-particle distance dispersity ranges from 0.75 to 1.25 in said cross-linked poly2,2,6,6-tetramethylpiperidinyl-oxy-4-yl-methacrylate). In a preferred embodiment, said cross-linked poly2,2,6,6-tetramethylpiperidinyl-oxy-4-yl-methacrylate) may have a percentage of cross-linking ranging from 3 to 7%. Preferably, said cross-linked poly2,2,6,6-tetramethylpiperidinyl-oxy-4-yl-methacrylate) may be obtained by the process according to present invention. Said cross-linked poly2,2,6,6-tetramethylpiperidinyl-oxy-4-yl-methacrylate) may have the output energy density values mentioned above.

The cross-linked poly2,2,6,6-tetramethyl-4-piperidinyl methacrylate) obtained according to the present process is useful for the preparation of cross-linked poly2,2,6,6-tetramethylpiperidinyl-oxy-4-yl-methacrylate), preferably comprising from 0.01 to 50 wt % of carbon conductive particles based on the total amount thereof.

### Example 1

Cross-linked PTMA/C composite was synthesized through a process according to the present invention. To enable the electrical conductivity, approx. 15% by weight of acetylene black was added to the reactant mixture. The present process produces a highly dispersed carbon conductive particles within a PTMA matrix with an intimate contact between the two components. The addition of acetylene black, i.e. carbon black, also was found to enhance the brittleness of the composite and ensured fine milling of the PTMA powder.

In a typical synthesis, 1 g of acetylene black (MTI Corporation) was thoroughly mixed with 6g of 2,2,6,6-tetramethyl-4-piperidinyl methacrylate (TMPM, TCI Co. Ltd.), 188 μl ethylene glycol dimethyl methacrylate cross-linking agent (Across Organics) and 40 mg of recrystallized azoisobutyronitrile (Across Organics) with the addition of minimal amount of dichloromethane (drop wise addition of 2-5 ml, Across Organics) to uniformly disperse the constituents. The mixture was thoroughly milled during and after the dichloromethane evaporation with the aid of 6 stainless-steel balls (2 mm in diameter).

Subsequently, the solid mixture was transferred into a glass vial, vacuum pumped and purged with argon three times. The sealed vial was heated slowly to 80° C. (approx. 30 minutes) to initiate and propagate the polymerization for 2 hours. At 65° C., 2,2,6,6-tetramethyl-4-piperidinyl methacrylate (melting temperature of 61° C.) melts generating a liquid dispersion, i.e. a slurry, of the constituents in molten monomer. After further 30 minutes, the mixture solidifies suggesting cross-linked polymerization. After cooling down, the solid content was washed with dichloromethane. The solid cross-linked poly2,2,6,6-tetramethyl-4-piperidinyl methacrylate) comprising the acetylene black particles (noted PTMPM/C hereunder) was finely grinded to yield a black-grayish powder (yield > 95%). The obtained product is insoluble in any organic solvent.

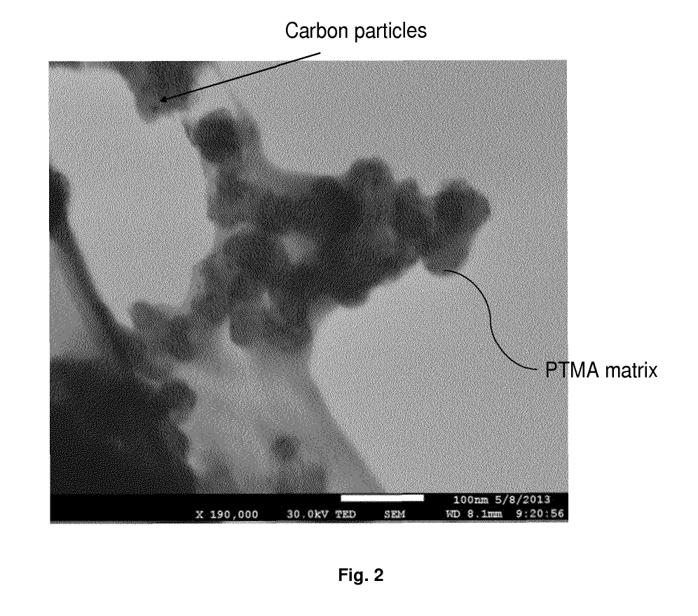

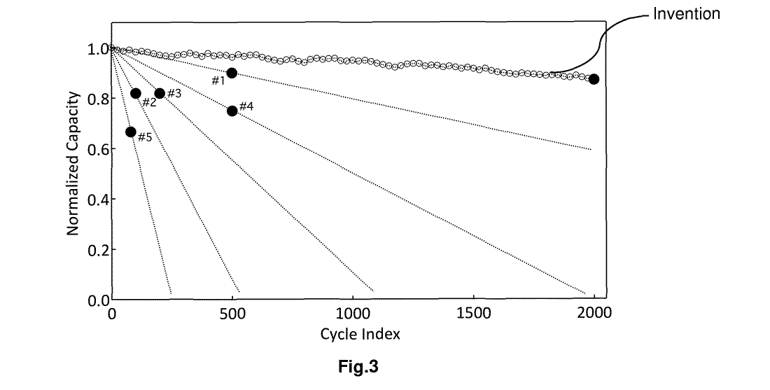

To synthesize the PTMA comprising the conductive carbon particles, 1 g of PTMPM/C (corresponding to 0.85 g, 3.77 mmol of poly2,2,6,6-tetramethyl-4-piperidinyl methacrylate)) was dispersed in 80 ml of dichloromethane with the aid of sonication. The dispersion was cooled down in an ice bath. The oxidation was performed using meta-chloroperoxybenzoic acid (mCPBA, Across Organics). The mCPBA was first purified by buffer phosphate washing to remove meta-chloroperoxybenzoic acid resulting in 30% weight loss. 680 mg (4 mmol, 1.05 equiv.) of freshly purified mCPBA was dissolved in 80 ml dichloromethane and cooled down in an ice bath. This solution was added drop wise to the PTMPM/C dispersion and left to react at 0° C. for 6 hours. The solid was filtered while cold and washed with cold (0° C.) dichloromethane first. The solid product was subsequently washed with dichloromethane, acetone, water and methanol. The obtained PTMA/C composite (yield >95%) was dried in vacuum and finely grinded before use. The synthesized PTMA/C yielded a specific capacity of 100 mAh/g. FIG. 2 represents the scanning transmission electron micrographs of a PTMA/carbon composite. Carbon black particles having a diameter around 5 to 15 nanometers embedded in a PTMA polymer matrix. The carbon black particles are well-dispersed within the polymer matrix allowing an enhanced conductivity of the polymer composite. The PTMA particles has mean diameter between 40 and 80 nm. The mean carbon-to-carbon particle distance (centre-to-centre) was around 15-20 nm, determined by scanning transmission electron micrographs. The particle-to-particle distance dispersity was around 1. The particle-to-particle dispersity refers to the mean distance between two particles determined by scanning transmission electron micrographs. FIG. 3 shows a graph representing the normalized capacity versus the cycle index of electrodes made of various polymer composites. The electrode made of an electrically conductive polymer composite according to the present invention loses only 12% of its capacity retention at 5C rate after 1500 cycles. The values of normalized capacity of electrodes according to the prior art are extracted from the literature: Data noted #1 from Chem. Phys. Lett. 2002, 359, 351-354, Data noted #2 from Journal of Power Sources 2007, 163, 1110-1113, Data noted #3 from Chemistry of Materials 2007, 19, 2910-2914, and data noted #4 from the NEC commercialized organic radical battery. Data noted #5 is obtained from solution based PTMA coated on carbon nanotubes. As shown in FIG. 3, the electrode made of electrically conductive polymer composite according to the present invention had greater capacity retention compared to the electrode known in the art.

### Example 2

PTMPM/C composite comprising 5 wt % of carbon black was prepared following the procedure detailed in Example 1 except that 0.33 g of acetylene black (MTI Corporation) were used. PTMA/C composite was then prepared as detailed in Example 1. The electrical conductivity was measured according techniques known in the art and was of 1.67*10⁻⁵ S/m.

### Example 3

PTMPM/C composite comprising 10 wt % of carbon black was prepared following the procedure detailed in Example 1 except that 0.67 g of acetylene black (MTI Corporation) were used. PTMA/C composite was then prepared as detailed in Example 1. The electrical conductivity was measured according techniques known in the art and was of 4.3*10⁻⁵ S/m. The PTMA/C composite prepared in this example had output energy density of 280 Wh/kg at a power density of 3.5 kW/kg (10C) while the output energy density was of 200 Wh/kg at power density of 10.23 kW/kg (30C).

### Example 4

PTMPM/C composite comprising 30 wt % of carbon black was prepared following the procedure detailed in Example 1 except that 2.57 g of acetylene black (MTI Corporation) were used. PTMA/C composite was then prepared as detailed in Example 1. The electrical conductivity was measured according techniques known in the art and was of 2.08 S/m.

### Example 5

PTMPM/C composite comprising 15 wt % of carbon black was prepared following the procedure detailed in Example 1 except that no dichloromethane was used to disperse the constituents. Said constituents are mixed thoroughly with planetary ball milling. The mixture is better dispersed. This may be due to the repelling nature of the carbon particles when using a solvent assisted mixing because separate monomer crystallization was occasionally observed.

### Example 6

PTMPM/C composite comprising 10 wt % of carbon black was prepared following the procedure detailed in Example 3 except that 100 mL of water per 1 gram of reaction mixture was added as dispersion media to form a suspension or an emulsion after heating above the melting point of monomer. PTMA/C composite was then prepared as detailed in Example 1.

### Comparative Example 7

(Solvent-Based Synthesis)

0.1 g of acetylene black (MTI Corporation) was thoroughly mixed with 0.9 g of 2,2,6,6-tetramethyl-4-piperidinyl methacrylate (TMPM, TCI Co. Ltd.), 30 μl ethylene glycol dimethyl methacrylate cross-linking agent (Across Organics) and 6 mg of recrystallized azoisobutyronitrile (Across Organics) with the addition of 100 mL of dioxane. Subsequently, the mixture was transferred into a glass vial, vacuum pumped and purged with argon three times. The sealed vial was heated slowly to 80° C. under agitation (approx. 30 minutes) to initiate and propagate the polymerization for 6 hours. After cooling down, the polymer was precipitated and washed with dichloromethane. The solid cross-linked poly2,2,6,6-tetramethyl-4-piperidinyl methacrylate) comprising the acetylene black particles (10 wt %). Comparative PTMA/C composite was then prepared as detailed in Example 1 with the so-prepared comparative PTMPM/C. The comparative PTMA/C composite had lower power performance, in particular output energy density compared to the PTMA/C of example 3 prepared according to the process of the present invention.

### Comparative Example 8

3 g of 2,2,6,6-tetramethyl-4-piperidinyl methacrylate (TMPM, TCI Co. Ltd.), 90 μl ethylene glycol dimethylmethacrylate cross-linking agent (Across Organics) and 20 mg of recrystallized azoisobutyronitrile (Across Organics) was mixed. The mixture was thoroughly milled with the aid of 6 stainless-steel balls (2 mm in diameter). Subsequently, the solid mixture was transferred into a glass vial, vacuum pumped and purged with argon three times. The sealed vial was heated slowly to 80° C. (approx. 30 minutes) to initiate and propagate the polymerization for 2 hours. After cooling down, the solid content was washed with dichloromethane. A poly2,2,6,6-tetramethyl-4-piperidinyl methacrylate) free of acetylene black particles was obtained. PTMA/C composite was then prepared by mixing PTMA with acetylene black particles while being swelled with dichloromethane (1 to 1 weight ratio) to provide a PTMA/C comprising 10 wt % of acetylene black particles. The comparative example provides a composite wherein the dispersion of acetylene black particles within PTMA is similar to that of FIG. 1A.

Table 1 below reports the normalized output energy density at 10C and 30C discharge rates after being charged at 0.5C (1C is equivalent to 105 mAh/g of PTMA compound) for the composite prepared in example 3 according to the present invention and for the comparative composites prepared according to comparative examples 7 and 8.

TABLE 1
Normalized output energy density for various PTMA/C composites

| | normalized output | normalized output |
|---|---|---|
| | energy density at 10 C | energy density at 30 C |
| Example 3 (Invention) | 1 | 1 |
| Example 7 (comparative) | 0.84 | 0.8 |
| Example 8 (comparative) | 0.6 | 0.45 |

The composite PTMA/C prepared according to the present invention had better output energy density than PTMA prepared according to other processes and having the same carbon content. The electrically conductive polymer composite, oxidized or not, prepared according to the present process has novel and surprising physical properties compared to PTMA/C known in the art.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated. As a consequence, all modifications and alterations will occur to others upon reading and understanding the previous description of the invention. In particular, dimensions, materials, and other parameters, given in the above description may vary depending on the needs of the application.

1. A process for the preparation of an electrically conductive polymer composite comprising the steps of:
(a) providing electrically conductive particles, a monomer, and a cross-linking agent to form a reaction mixture,
(b) bringing said reaction mixture to a process temperature which is greater than the melting temperature of the monomer and than the temperature at which the polymerization is activated, said polymerization is considered to be activated when at least 5% of the monomer was converted,
(c) retrieving a cross-linked electrically conductive polymer composite comprising said electrically conductive particles,
characterized in that said monomer is of formula (I)
R^{a}R^{b}C=CR^{c}((X)ₙ-R) (I)
wherein
R^{a}, R^{b}, and R^{c} each are, independently from the other, hydrogen or an hydrocarbyl group having from 1 to 20 carbon atoms,
X is a spacer, n is an integer from 0 to 5,
R is a substituent having a nitroxide radical or a radical localized on a quinone or hydroquinone functional group; or R is a substituent having a nitrogen atom able to form nitroxide radicals under oxidative conditions or having quinone or hydroquinone functional groups, and
in that
step (b) of the process is carried out in a reaction mixture comprising not more than 100 wt % of a solvent with respect to the total weight of the monomer.

2. A process according to claim 1 wherein step (b) of the process is carried out in a reaction mixture comprising not more than 30 wt % of a solvent with respect to the total weight of the monomer.

3. A process according to claim 1 wherein step (b) is carried out sequentially by:
(b′) bringing said reaction mixture to a first process temperature to form a slurry where the polymerization reaction has not been initiated, said polymerization is considered to be not initiated when less than 5% of the monomer was converted,
(b″) heating said slurry to a second process temperature higher than the first process temperature to activate the polymerization and thus to polymerize the monomer, and steps (b′) and (b″) of the process is carried out in a reaction mixture comprising not more than 100 wt %, preferably not more than 30 wt %, of a solvent with respect to the total weight of the monomer.

4. A process according to claim 1 wherein steps (b) or (b′) and (b″) of the process are carried out in a reaction mixture or slurry free of any organic solvent.

5. A process according to claim 3 wherein the first process temperature is higher or equal to the melting temperature of the monomer.

6. A process according to claim 3 wherein the slurry is maintained at the first process temperature under stirring conditions to homogeneously disperse the electrically conductive particles while maintaining the slurry at a low and substantially constant viscosity prior to step (c).

7. (canceled)

8. A process according to claim 1 wherein the electrically conductive particles are carbon conductive particles or, metallic nanowires or particles selected from the group consisting of silver, nickel, iron, copper, zinc, gold, tin, indium or oxides thereof, preferably carbon conductive particles.

9. A process according to claim 1 wherein a dispersion media is provided in step (a), said dispersion media being insoluble or immiscible with said solvent or said monomer.

10. A process according to claim 1 wherein the monomer is of formula (I) wherein R^{a}, R^{b}, R^{c} are hydrogen, n is O and R is selected from the group consisting of:

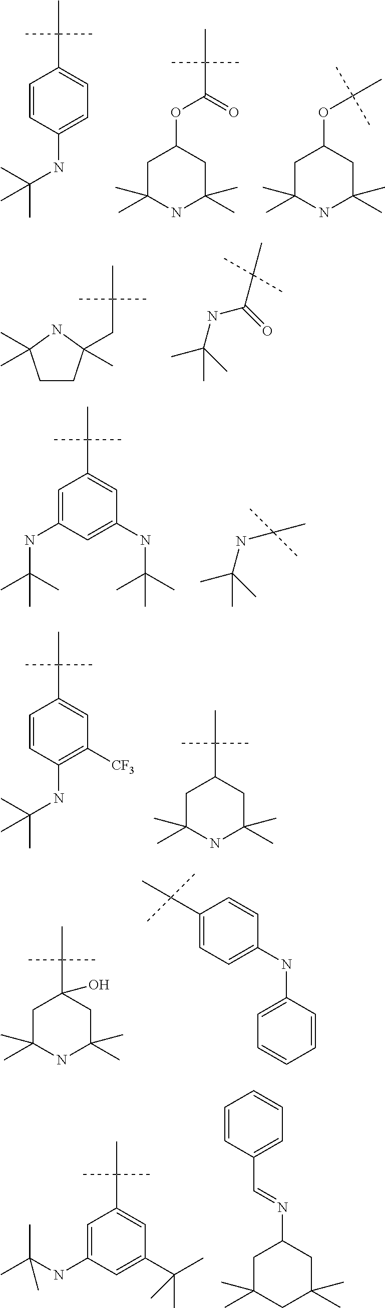

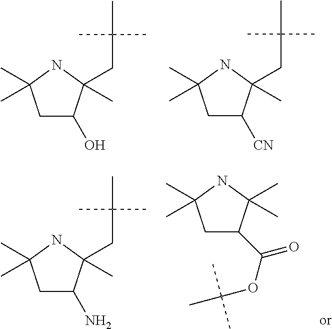

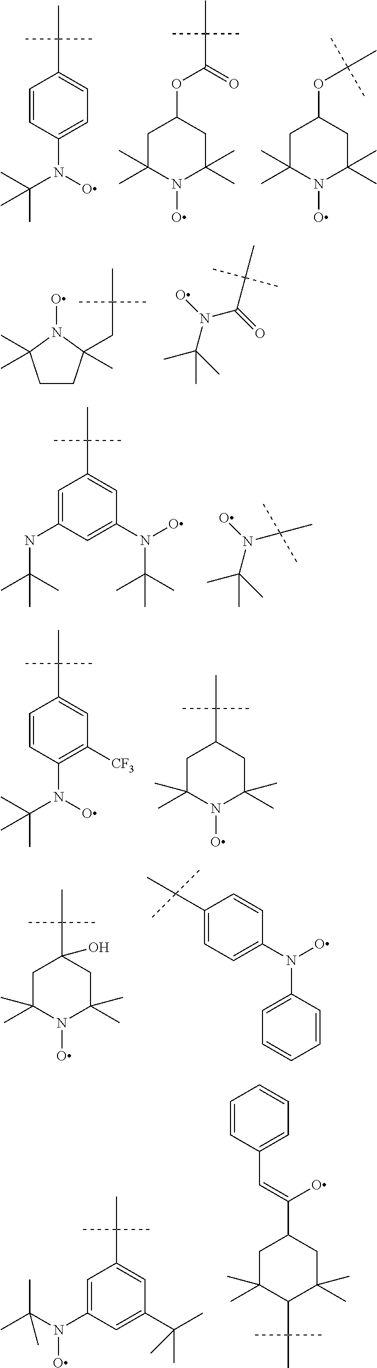

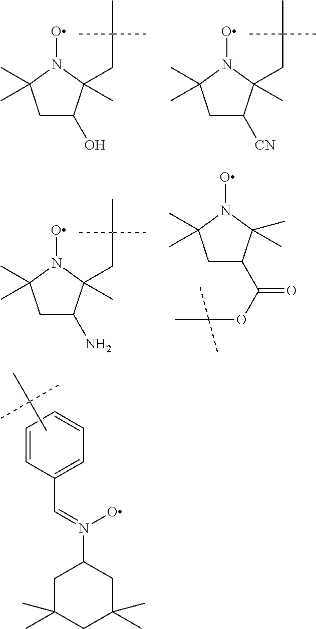

11. A process according to claim 10 wherein the monomer is 2,2,6,6-tetramethyl-4-piperidinyl methacrylate or 2,2,6,6-tetramethylpiperidinyl-oxy-4-yl-methacrylate.

12. A process according to claim 3 wherein radical polymerization initiator is provided in step (a), and step (b′) is carried out at a first process temperature higher or equal to the melting temperature of the monomer, and step (b″) is carried out at a second process temperature higher than the temperature at which radical polymerization initiator activates the polymerization of the monomer, the polymerization of the monomer is considered activated when at least 5 wt % of the monomer is converted.

13. A process according to claim 1 further comprising the step (d) of oxidizing the electrically conductive polymer composite obtained in step (c) when said electrically conductive polymer composite is free of nitroxide radicals.

14. (canceled)

15. An electrically conductive polymer composite being a cross-linked poly2,2,6,6-tetramethyl-4-piperidinyl methacrylate) comprising from 0.01 to 50 wt % of carbon conductive particles based on the total amount of the conductive polymer composite.

16. An electrically conductive polymer composite according to claim 15 characterized in that it has a percentage of cross-linking ranging from 3 to 7%.

17. (canceled)

18. Use of the electrically conductive polymer composite according to claim 15 for the preparation of cross-linked poly2,2,6,6-tetramethylpiperidinyl-oxy-4-yl-methacrylate) comprising from 0.01 to 50 wt % of carbon conductive particles based on the total amount thereof.

19. An electrically conductive polymer composite or an oxidized electrically conductive polymer composite being a cross-linked poly2,2,6,6-tetramethylpiperidinyl-oxy-4-yl-methacrylate) comprising from 0.01 to 50 wt % of carbon conductive particles based on the total amount of said conductive polymer composite, wherein the carbon conductive particles are homogeneously dispersed within the cross-linked poly2,2,6,6-tetramethylpiperidinyl-oxy-4-yl-methacrylate).

20. An oxidized or not electrically conductive polymer composite according to claim 19 wherein the mean carbon-to-carbon particle distance ranges from 1 to 100 nm, preferably from 5 to 50 nm, more preferably from 10 to 30 nm.

21. An oxidized or not electrically conductive polymer composite according to claim 19 wherein the particle-to-particle distance dispersity ranges from 0.75 to 1.25.

22. (canceled)

23. An oxidized or not electrically conductive polymer composite according to claim 19 obtained by the process comprising the steps of:
(a) providing electrically conductive particles, a monomer and a cross-linking agent to form a reaction mixture,
(b) bringing said reaction mixture to a process temperature which is greater than the melting temperature of the monomer and than the temperature at which the polymerization is activated, said polymerization is considered to be activated when at least 5% of the monomer was converted,
(c) retrieving a cress-linked electrically conductive polymer composite comprising said electrically conductive particles,
characterized in that said monomer is of formula (I)
R^{a}R^{b}C=CR^{c}((X)ₙ-R) (I)
wherein
R^{a}, R^{b}, and R^{c} each are, independently from the other, hydrogen or an hydrocarbyl group haying from 1 to 20 carbon atoms,
X is a spacer, n is an integer from 0 to 5,
R is a substituent having a nitroxide radical or a radical localized on a quinone or hydroquinone functional group; or R is a substituent having a nitrogen atom able to form nitroxide radicals under oxidative conditions or haying quinone or hydroquinone functional groups, and
in that
step (b) of the process is carried out in a reaction mixture comprising not more than 100 wt % of a solvent with respect to the total weight of the monomer.

24. A positive electrode comprising an oxidized or not electrically conductive polymer composite according to claim 19.
